(19) United States
(12) Patent Application Publication
(10) Pub. No.: US 2025/0115295 A1
(43) Pub. Date: Apr. 10, 2025

(54) METHOD OF CORRECTLY PREDICTING TRAILER TRAJECTORY WHILE REVERSING

(71) Applicant: Panasonic Automotive Systems Company of America, Division of Panasonic Corporation of North America, PEACHTREE CITY, GA (US)

(72) Inventors: JIN WOO JUNG, JOHNS CREEK, GA (US); JAGADESH NISCHAL NAGIREDDI, PEACHTREE CITY, GA (US)

(21) Appl. No.: 18/906,552

(22) Filed: Oct. 4, 2024

Related U.S. Application Data
(60) Provisional application No. 63/588,396, filed on Oct. 6, 2023.

(51) Int. Cl. B62D 13/06; B60W 30/06; B60W 30/18; B62D 15/02; G06V 20/56

(52) U.S. Cl. CPC B62D 13/06; B60W 30/06; B60W 30/18036; B62D 15/0275; B62D 15/0285; G06V 20/56; B60W 2300/14

(57) ABSTRACT

Locations of a left wheel and a right wheel of the trailer are determined when the motor vehicle is at a first point. An electronic processor calculates an instantaneous center of curvature of the trailer when the motor vehicle is at a first point. The calculating is based upon an instantaneous center of curvature of the motor vehicle, a location of a hitch point, and the locations of the left and right wheels of the trailer. The electronic processor predicts locations of the left and right wheels of the trailer at a future time when the motor vehicle has moved to a second point. The predicting is based upon the instantaneous center of curvature of the trailer when the motor vehicle is at the first point, a difference between the first point and the second point, and the locations of the left and right wheels of the trailer.

### CROSS-REFERENCED TO RELATED APPLICATIONS

This application claims benefit of U.S. Provisional Application No. 63/588,396, filed on Oct. 6, 2023, the disclosure of which is hereby incorporated by reference in its entirety for all purposes.

### BACKGROUND OF THE INVENTION

### 1. Field of the Invention

The present invention relates to predicting the path of a trailer pushed by a motor vehicle in reverse gear.

### 2. Description of the Related Art

When a trailer is attached to a car and the car is reversing, it is difficult for the driver to understand and estimate the trailer behavior while reversing. To help the driver reversing in that case (through visualization, automatic control, etc.), correctly predicting the trailer path is the key, which is also a nontrivial problem.

Many modern cars with a rear-view camera have dynamic guidelines showing the car's future trajectory in the infotainment screen based on the steering mechanism. This is possible due to an existing well-established knowledge of car movement. FIG. 1 is a prior art image illustrating a rear-view camera's video feed with overlayed dynamic guidelines. The solid lines 10 may indicate the predicted path of the tires, and the dashed lines 12 may indicate the predicted path of the respective widest points on the opposite lateral sides of the vehicle's body.

When people attach a trailer to the back of their vehicle, a vehicle's rear-view camera is not useful for checking the rear of the trailer. To enable the driver of a motor vehicle 14 (FIG. 2) to check what is behind a trailer 16, a wireless camera 18 can be attached to the rear of trailer 16. However, there is no known way to predict the path of the trailer when driving in reverse. The path of trailer 16 may depend on both the steering angle of the vehicle's front tires 20 and a hitch angle 22 having a hitch point 24 at its vertex. Consequently, there is no known way to present to the driver a predicted path of the trailer.

The reversing movement (e.g., trajectory) of the car itself is well established since modern cars use the Ackermann steering system. The Ackermann steering system reduces the car's tire wear by allowing each tire to move on a unique trajectory. When the steering wheel is rotated, all the wheels align such that a perpendicular line drawn from the center of the wheels point to a single point called the Instantaneous Center of Curvature of the Car (ICC-Car). This is illustrated in FIG. 3, which shows the Ackermann steering system of a car 14 turning right along with the car's Instantaneous Center of Curvature point (ICC-Car) and car movement (trajectory). Dashed circles denote the trajectory of each tire and the hitch point. When the steering wheel angle is fixed (which fixes and determines ICC-Car), the movement of car 14 will be on the dashed circular path in both forward and backward motion.

For a constant steering wheel angle, the car's instantaneous center of curvature (ICC) is a fixed point, and this point will not change until the driver adjusts the steering wheel. Due to this, we have a precise method of understanding the movement (trajectory) of car 14 according to the steering wheel angle.

### SUMMARY OF THE INVENTION

The invention may accurately predict the future trajectory of a trailer while reversing, thereby enabling the drawing of dynamic guidelines on a display screen when reversing.

The invention may enable better path predictions to be made for a trailer.

The invention comprises, in one form thereof, a path prediction arrangement for a trailer hitched to a motor vehicle, including means for determining locations of a left wheel and a right wheel of the trailer when the motor vehicle is at a first point. An electronic processor is communicatively coupled to the determining means and calculates an instantaneous center of curvature of the trailer when the motor vehicle is at a first point. The calculating is based upon an instantaneous center of curvature of the motor vehicle, a location of a hitch point between the motor vehicle and the trailer, and the locations of the left wheel and the right wheel of the trailer. The electronic processor predicts locations of the left wheel and the right wheel of the trailer at a future time when the motor vehicle has moved to a second point. The predicting is based upon the instantaneous center of curvature of the trailer when the motor vehicle is at the first point, a difference between the first point and the second point, and the locations of the left wheel and the right wheel of the trailer when the motor vehicle is at the first point. A display screen presents an image indicating the predicted locations of the left wheel and the right wheel of the trailer at the future point in time when the motor vehicle has moved to the second point.

The invention comprises, in another form thereof, a method for predicting a path of a trailer that is coupled to a motor vehicle, including determining locations of a left wheel and a right wheel of the trailer when the motor vehicle is at a first point. An instantaneous center of curvature of the trailer when the motor vehicle is at a first point is calculated. The calculating is based upon an instantaneous center of curvature of the motor vehicle, a location of a hitch point between the motor vehicle and the trailer, and the locations of the left wheel and the right wheel of the trailer. Locations of the left wheel and the right wheel of the trailer at a future time when the motor vehicle has moved to a second point are predicted. The predicting is based upon the instantaneous center of curvature of the trailer when the motor vehicle is at the first point, a difference between the first point and the second point, and the locations of the left wheel and the right wheel of the trailer when the motor vehicle is at the first point. An image indicating the predicted locations of the left wheel and the right wheel of the trailer at the future point in time when the motor vehicle has moved to the second point is presented on a display screen.

The invention comprises, in yet another form thereof, a path prediction arrangement for a trailer hitched to a motor vehicle, including means for determining locations of a left wheel and a right wheel of the trailer when the motor vehicle is at a first point. An electronic processor is communicatively coupled to the determining means and calculates an instantaneous center of curvature of the trailer when the motor vehicle is at the first point. The calculating is based upon an instantaneous center of curvature of the motor vehicle, a location of a hitch point between the motor vehicle and the trailer, and the locations of the left wheel and the right wheel of the trailer. The electronic processor predicts locations of the left wheel and the right wheel of the trailer at a future time when the motor vehicle has moved to a second point. The predicting is based upon the instantaneous center of curvature of the trailer when the motor vehicle is at the first point, a difference between the first point and the second point, and the locations of the left wheel and the right wheel of the trailer when the motor vehicle is at the first point. An autonomous driving system is communicatively coupled to the electronic processor and autonomously parks the motor vehicle and the trailer dependent upon the predicted locations of the left wheel and the right wheel of the trailer at the future point in time when the motor vehicle has moved to the second point.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a prior art image showing a rear-view camera's video feed with overlayed dynamic guidelines.

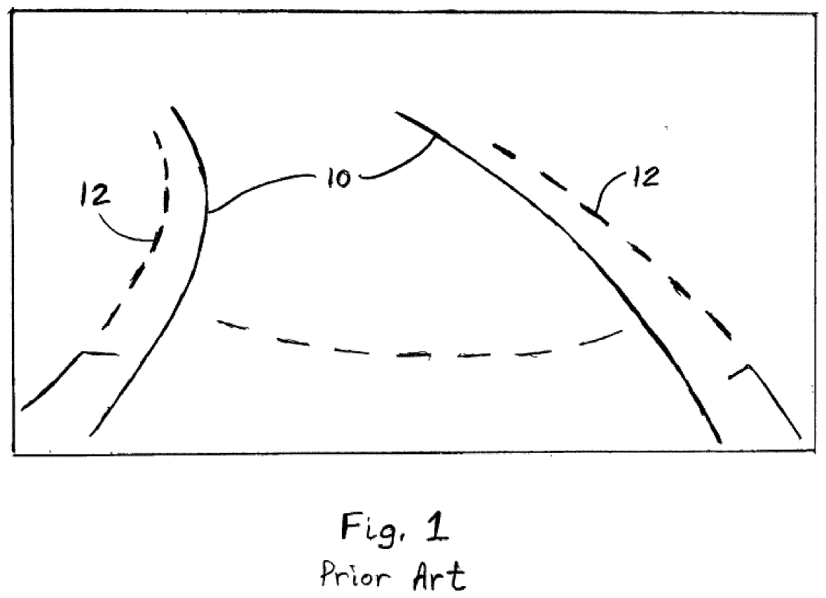

FIG. 2 is a schematic diagram of a car and trailer arrangement of the prior art.

FIG. 3 is a schematic diagram of a relationship between wheel steering angle and the instantaneous center of curvature with an Ackermann steering system of the prior art.

FIG. 4 is a schematic diagram of a kinematic model of the present invention of a car-trailer system.

FIG. 5 is a schematic diagram showing the trajectories of the car and trailer of FIG. 4 based on their instantaneous centers of curvature.

FIG. 6 is a schematic diagram showing the trajectories of the car and hitch point of FIG. 4 relative to the car's instantaneous centers of curvature.

FIG. 7 is a schematic diagram adding the trailer of FIG. 5 to the diagram of FIG. 6.

FIG. 8 is a schematic diagram showing the car of FIG. 7 in position 2.

FIG. 9 is a schematic diagram showing the trailer's instantaneous center of curvature changes when the car of FIG. 7 moves from position 1 to position 2.

FIG. 10 is a schematic diagram showing the car of FIG. 7 in position 3.

FIG. 11 is a schematic diagram showing an incorrectly predicted trailer trajectory based on only the initial conditions of FIG. 7.

FIG. 12 is a schematic diagram of a trailer trajectory predicted correctly according to the present invention based on the simulated car-trailer system movement shown in FIGS. 7, 8 and 10.

FIG. 13 is a schematic diagram showing a technique of the invention in which a movement by the car is broken down into smaller steps.

FIG. 14 is a schematic diagram showing how the trailer wheel location at Point 2 can be obtained.

FIG. 15 is a schematic diagram showing an updated trailer trajectory prediction for the car moving from Point 2 to Point 3.

FIG. 16 is a flow chart of one embodiment of an iterative method of the invention for predicting trailer trajectory.

FIG. 17 is a flow chart of one embodiment of a method of the invention for obtaining necessary values (ICC-Car and Hₙ) for trailer trajectory prediction.

FIG. 18 is a flow chart of the first iteration (Point 1 to 2) of the trailer trajectory prediction method of FIG. 16.

FIG. 19 is a schematic diagram showing a trailer parking assistance method of the present invention.

FIG. 20 is a block diagram of one embodiment of a vehicle self-parking arrangement of the present invention.

FIG. 21 is a flow chart of one embodiment of a method of the present invention for predicting a path of a trailer that is coupled to a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

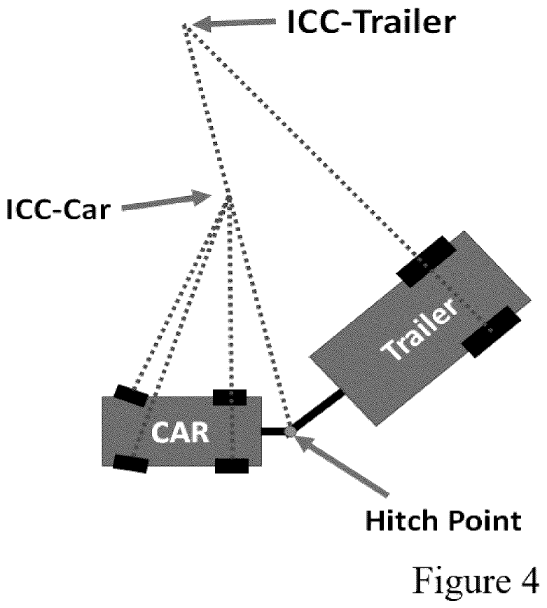

FIG. 4 illustrates a kinematic model of the present invention of a car-trailer system. When it comes to the trailer movement (e.g., trajectory) prediction when reversing, both the car and the trailer move on different trajectories according to their respective kinematics of motion, which is shown in FIG. 4. The point about which an object rotates is called the instantaneous center of curvature (ICC) as introduced earlier. The car and the trailer have different instantaneous centers of curvature points (ICC-Car and ICC-Trailer, respectively) for a given steering wheel angle and hitch angle as shown in FIG. 4.

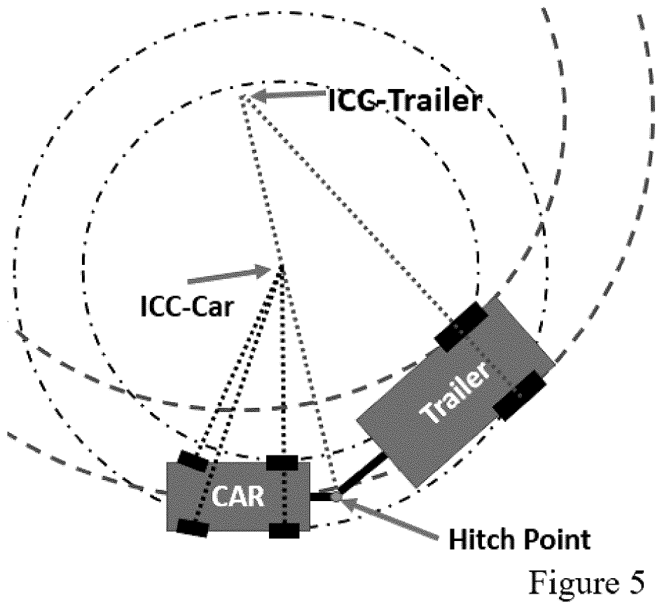

FIG. 5 illustrates the trajectories of the car and trailer of FIG. 4 based on their instantaneous centers of curvature. Circles in FIG. 5 show how the future trajectory of both car and trailer would be based on the two ICCs shown in FIG. 4. The dash-dotted circle shows the path of the car wheels for the rear axle. The dashed circle shows the path of the trailer wheels at that instance.

As explained earlier, for a constant steering wheel angle, the car's instantaneous center of curvature (ICC-Car) is a fixed point, and this point will not change unless the driver adjusts the steering. However, even with a constant steering wheel angle, the instantaneous center of curvature of the trailer (ICC-Trailer) dynamically changes over time. To understand this, we need to know how ICC-Trailer can be obtained. To calculate ICC-Trailer, the intersection of the following two lines is needed:
1) Line joining the hitch point and the car's instantaneous center of curvature point (ICC-Car).
2) Line joining the trailer's left and right wheels (Along the trailer's axle).
   The dotted lines in FIG. 4 and FIG. 5 show how ICC-Trailer is obtained.

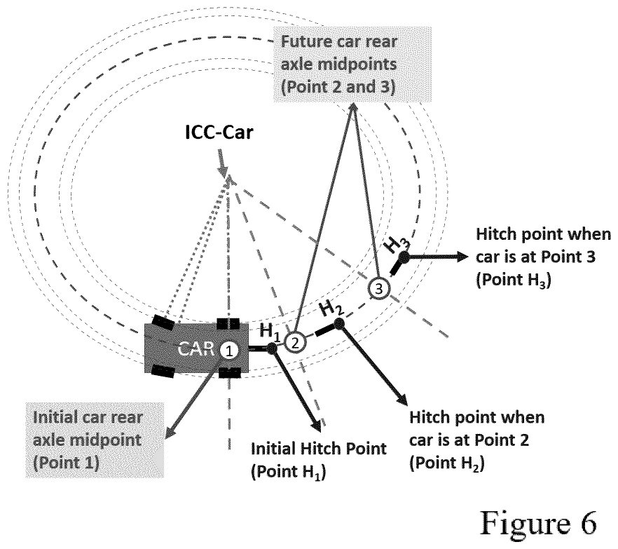

FIG. 6 shows the initial car rear axle midpoint location (Point 1), and samples of future car rear axle midpoint locations (Points 2 and 3). Points H₁, H₂, and H₃ indicate the hitch locations when the car rear axle midpoint is at Points 1, 2 and 3, respectively.

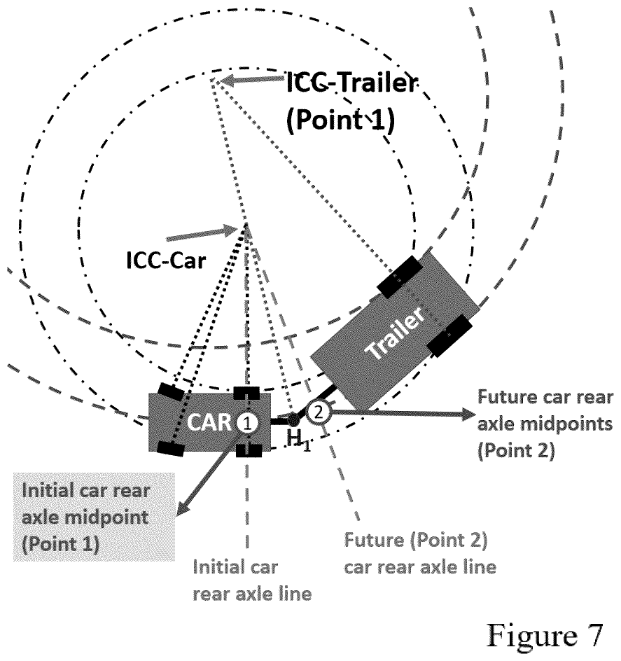

Assume that in FIG. 6 the car is reversing with a fixed steering wheel from Point 1. If we add the trailer from FIG. 5 to FIG. 6, we get FIG. 7, which shows the case where the car is in the initial location (Point 1).

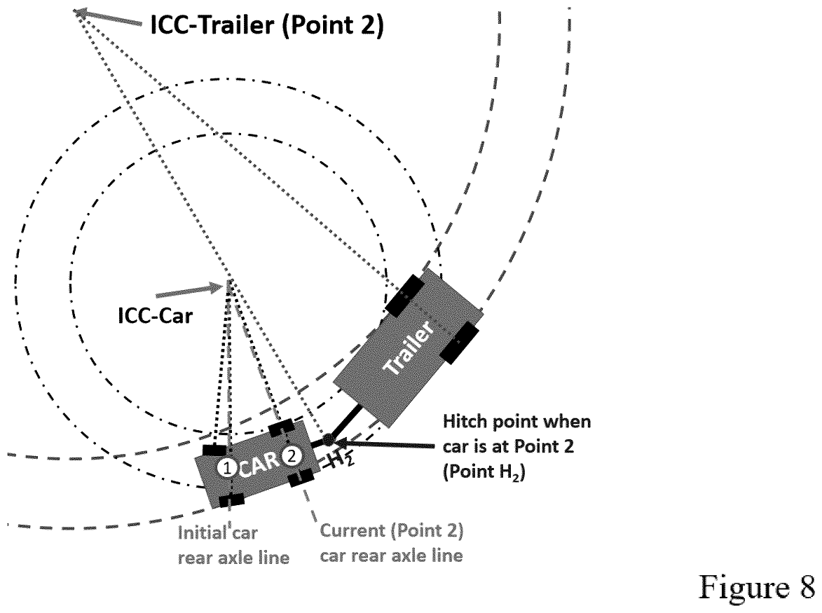

FIG. 8 shows the case where the car moved from Point 1 to Point 2 (reversing). ICC-Car stays the same as long as the steering wheel is fixed when moving from the initial position to Point 2. However, as can be seen in comparing FIGS. 7 and 8, ICC-Trailer moves from the inside of the dash-dotted circle in FIG. 7 to the outside in FIG. 8.

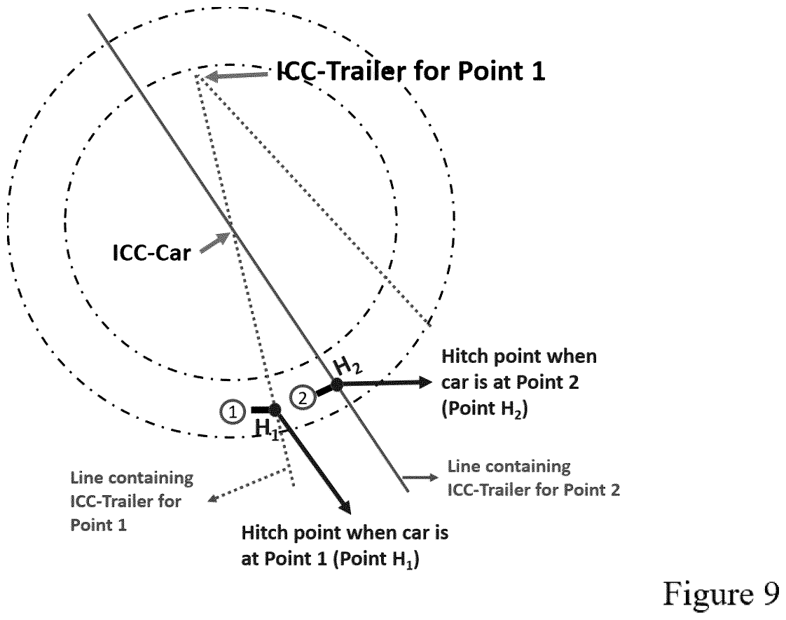

FIG. 9 illustrates intuitively why ICC-trailer changes when the car moves, unlike ICC-car. The dotted line (i.e., the line connecting ICC-Car and Point H₁) is one of the lines that defines ICC-Trailer when the car is at Point 1 (ICC-Trailer for Point 1 in FIG. 9). The solid line (line connecting ICC-Car and Point H₂) is one of the lines that defines ICC-Trailer when the car is at Point 2 (ICC-Trailer for Point 2, which is not shown in FIG. 9). Since the solid line does not intersect ICC-Trailer for Point 1, ICC-Trailer for Point 2 must be different from ICC-Trailer for Point 1.

In FIG. 9, the solid line, which is the line connecting ICC-Car and hitch point H₂, should contain ICC-Trailer when the car is at Point 2 because, as mentioned earlier, ICC-Trailer should be on the line joining the hitch point and ICC-Car. This solid line does not intersect ICC-Trailer for Point 1 in FIG. 9, which means that ICC-Trailer when the car is at Point 2 is different from ICC-Trailer when the car is at Point 1 (ICC-Trailer for Point 1).

Since ICC-Trailer changes dynamically as the car moves even with a fixed steering wheel, the future trajectory of the trailer changes too, which can be seen from the different dashed circles (trailer trajectories) in FIGS. 7 and 8.

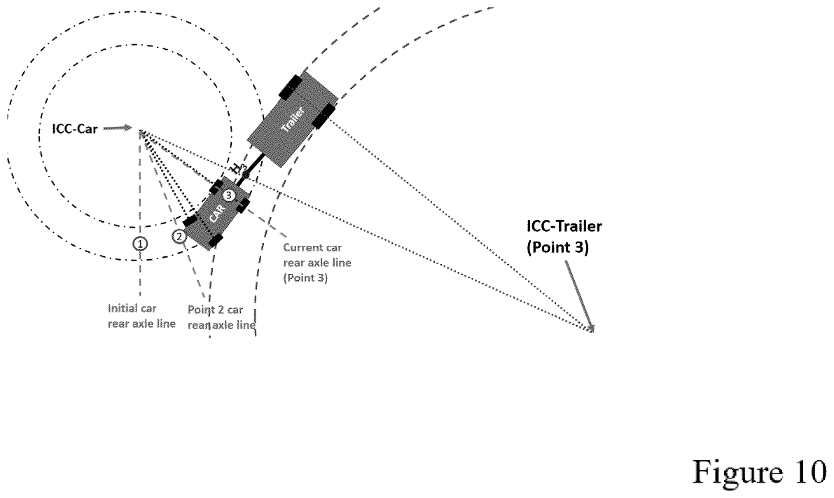

Even more extreme change can happen as the car moves from Point 2 to Point 3, which is shown in FIG. 10. As can be seen in FIG. 10, due to the change in the hitch angle, ICC-Trailer (Point 3) is now on the opposite side of the car-trailer system.

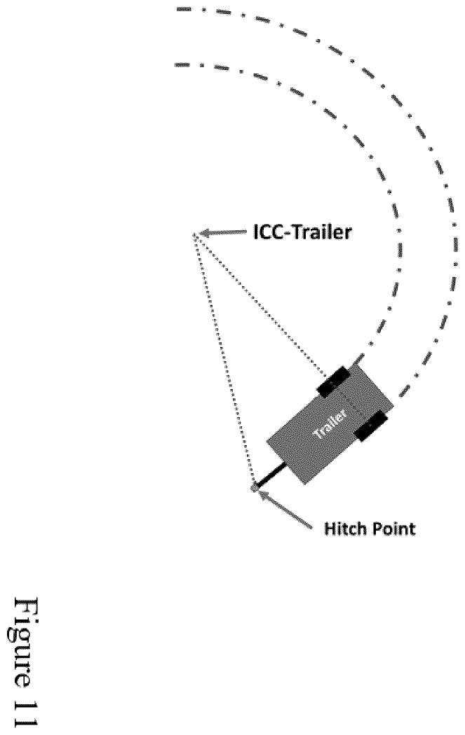

The above examples illustrate the problem of correctly estimating the trailer's future trajectory. If only the initial conditions of the car-trailer system are considered, then the future trailer trajectory will be incorrectly predicted. For example, considering only the initial ICC-Trailer (Point 1) and the trajectory of the trailer based on that (shown by the dashed circle in FIG. 7), would result in the incorrectly predicted trailer trajectory shown in FIG. 11. That is, FIG. 11 illustrates an incorrect trajectory prediction of the trailer using only the initial configuration of the car-trailer system in FIG. 7.

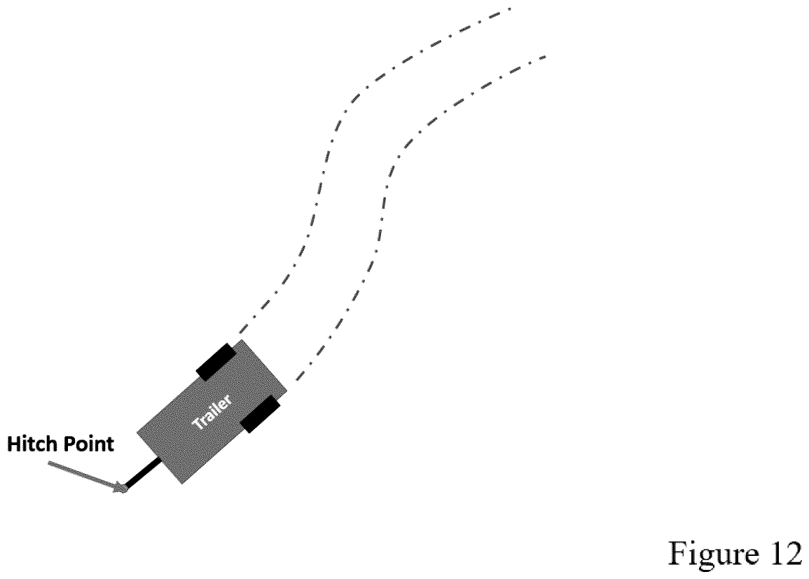

The trailer trajectory prediction in FIG. 11 is incorrect due to the ICC-Trailer point constantly changing as can be observed in FIGS. 7 through 10. In contrast, the present invention enables the predicting of a correct trailer trajectory, as shown in FIG. 12.

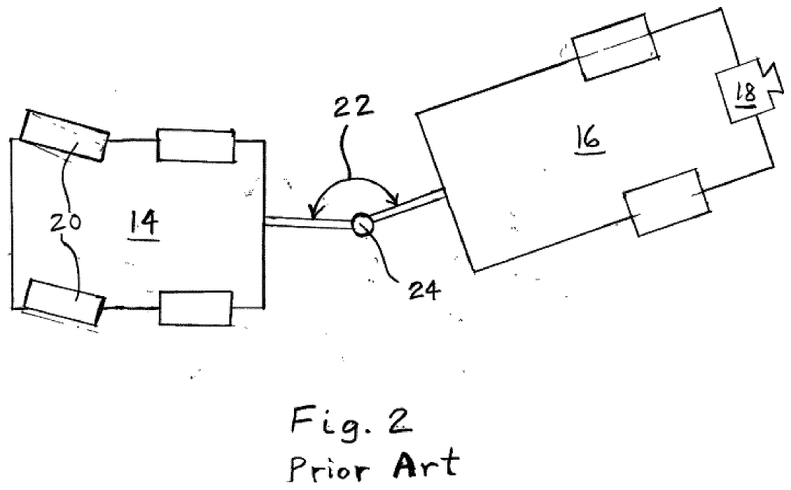

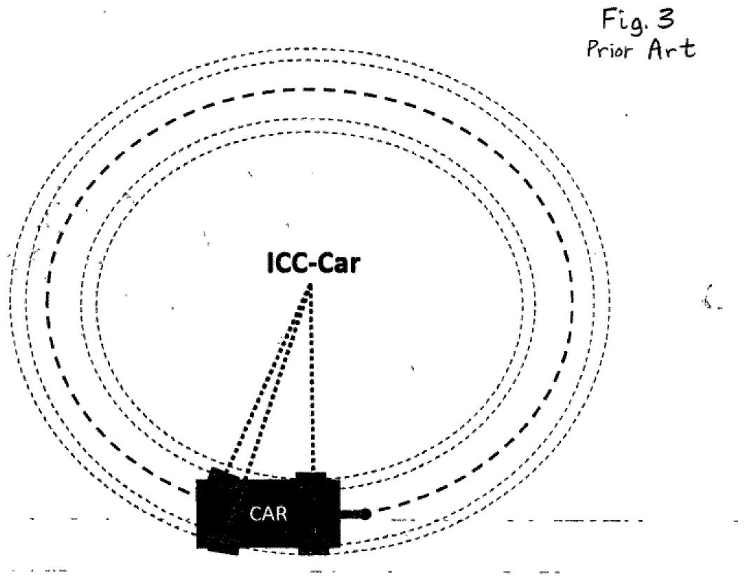

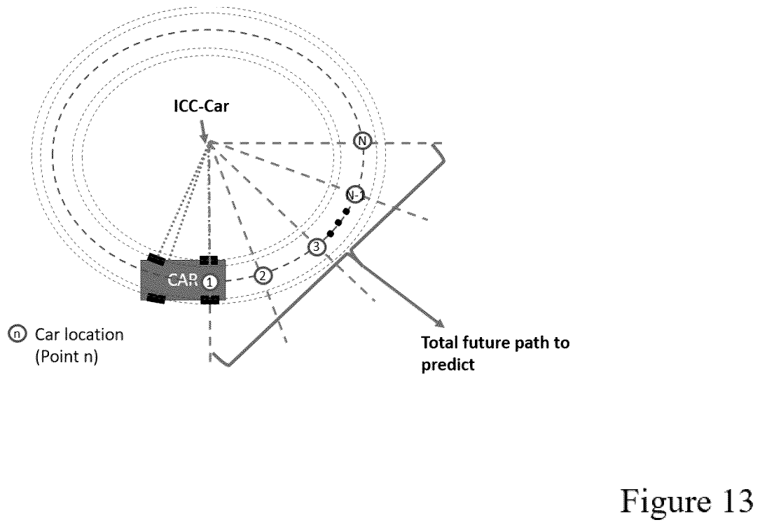

This invention may address the trailer trajectory prediction problem by analyzing what the car-trailer system movement will be in the future and accordingly generating an accurate trailer trajectory prediction. As mentioned earlier, the reverse motion of the car can be easily predicted using ICC-Car concept. With a fixed steering wheel angle, the car follows a circular path (ICC-Car in FIG. 3). With the steering angle at zero degrees, the car will move in a straight line, not circular. However, this case can also be treated as still following the ICC-Car concept by obtaining ICC-Car when the steering wheel angle is very small (close to zero). So, regardless of the steering wheel angle, ICC-Car can be obtained and used for car path prediction. Then, the predicted path of the car can be broken down into multiple small sample locations as shown in FIG. 13. As can be seen in FIG. 13, the target end point N indicates how far we want to predict, and there are total N number of sample car locations (Points 1 to N) along the future car path (including the current location, Point 1). Note that the car location does not necessarily have to be defined as the rear axle midpoint as in FIG. 13, and it can be any reference point in or around the car. Also note that the N samples do not have to be equally spaced. Because the hitch point (FIG. 2) location relative to the car is always fixed once the hitch has been installed, for the case of the car being at one sample location in FIG. 13, corresponding hitch point locations can be easily calculated. The hitch point when the car is in the sample location n, will be denoted by Hₙ (H₁, H₂, . . . , H_{N}) as in FIG. 6.

Next, from one sample car location to the next (adjacent), a correct trailer trajectory prediction is needed, which can be done by obtaining trailer wheel locations and ICC-Trailer at each sample car location. This is explained in detail below.

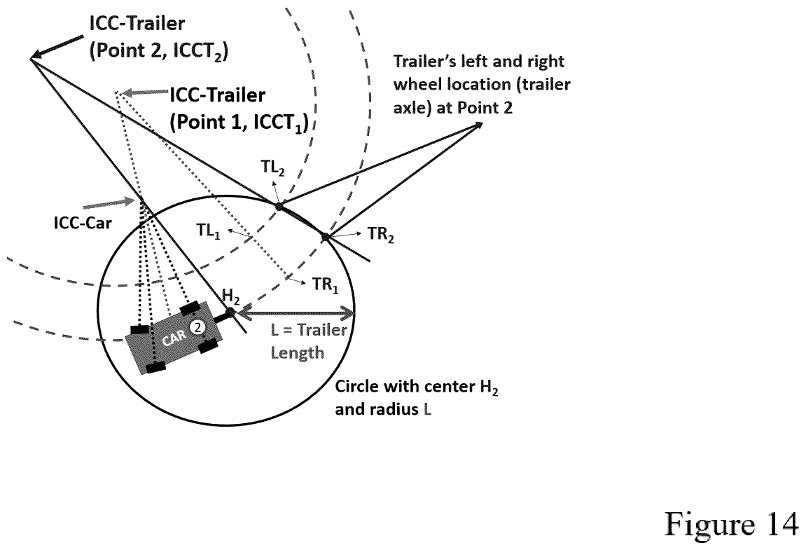

Let ICCTₙ denote ICC-Trailer at the sample car location of n. Since the hitch point can be easily obtained at location n and ICC-Car remains the same, the only thing remaining that is needed to determine ICCTₙ is the location of the trailer's left and right wheels, as shown in FIG. 7. Let TLₙ and TRₙ denote the location of the trailer's left and right wheels, respectively, when the car is at Point n. For TL₁ and TR₁ (trailer wheel locations when the car is at Point 1), we can assume that it is known because multiple approaches can be used to find TL₁ and TR₁ relative to the car (like by estimating hitch angle through a camera, sensors, etc.). Now, from Point 1 to Point 2, the path that the trailer follows is ICCT₁'s circular movement since there is no other trailer path available. At Point 2, we obtain ICCT₂, and use that for trailer trajectory prediction for moving from Point 2 to Point 3. To do that, TL₂ and TR₂ need to be obtained, and one of the ways to achieve that is as follows. At Point 2, TL₂ and TR₂ are still on the circles of ICCT₁, and when the trailer length from the front to the trailer axle is denoted by L, the trailer is L distance away from the hitch point, H₂. With this knowledge, it is not difficult to see that TL₂ and TR₂ can be obtained by finding the intersecting points between ICCT₁'s circles (dashed circles in FIG. 14) and a circle with center H₂ and radius L (solid circle in FIG. 14). FIG. 14 illustrates how the trailer wheel locations at Point 2 can be obtained by using H₂, L, and ICCT₁. ICC-Trailer at Point 2 (ICCT₂) can then be obtained by using ICC-Car, H₂, and the trailer wheel location at Point 2.

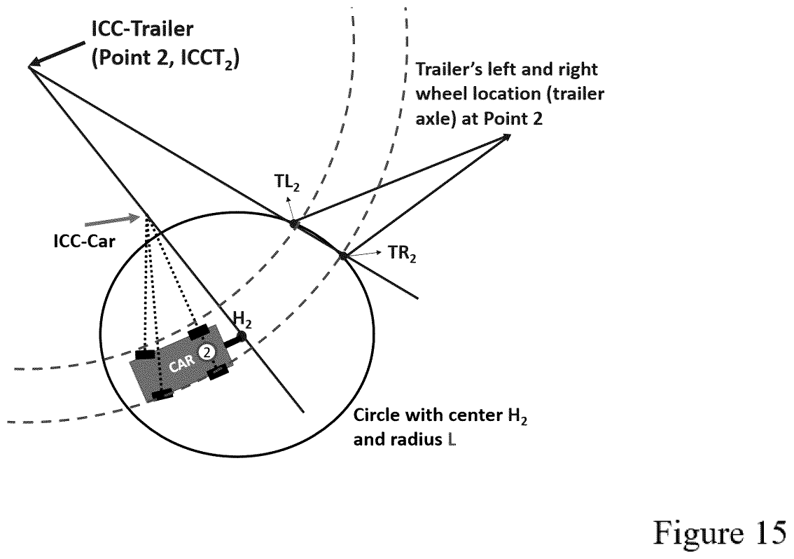

Note that the above description is of one way to get TL₂ and TR₂ easily and correctly, and the core idea of this invention disclosure is not restricted to this particular method of getting TLₙ and TRₙ. With TL₂ and TR₂, ICCT₂ can now be obtained as shown in FIG. 14. TL₂ and TR₂ can also be used to find the points at which the usage of ICCT₁'s circles ends for trailer trajectory prediction (and the usage of ICCT₂'s circles starts). That is, the dashed curve from TL₁ to TL₂ and the dashed curve from TR₁ to TR₂ in FIG. 14 show where the trailer movement starts and ends for the car moving from Point 1 to Point 2. The new trailer trajectory from Point 2 to Point 3 can be obtained by drawing a new circle around ICCT₂ that intersects trailer wheels' location at Point 2 (TL₂ and TR₂), which is shown in FIG. 15.

In FIG. 15, dashed circles show the updated trailer trajectory prediction for the car moving from Point 2 to Point 3, which is obtained from the trailer wheel location at Point 2 (TL₂ and TR₂) and new ICC-Trailer at Point 2 (ICCT₂).

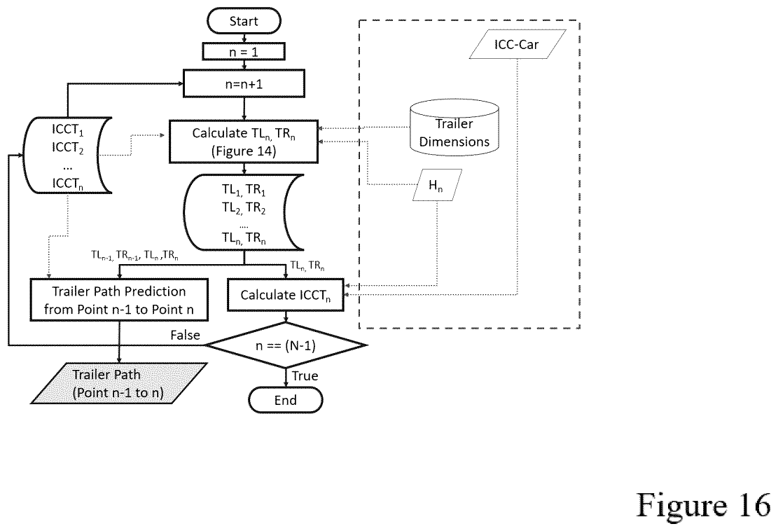

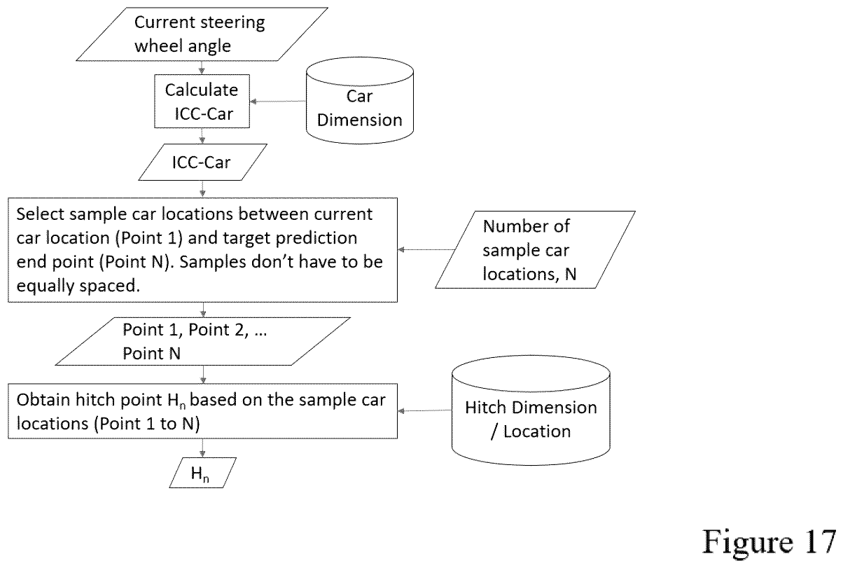

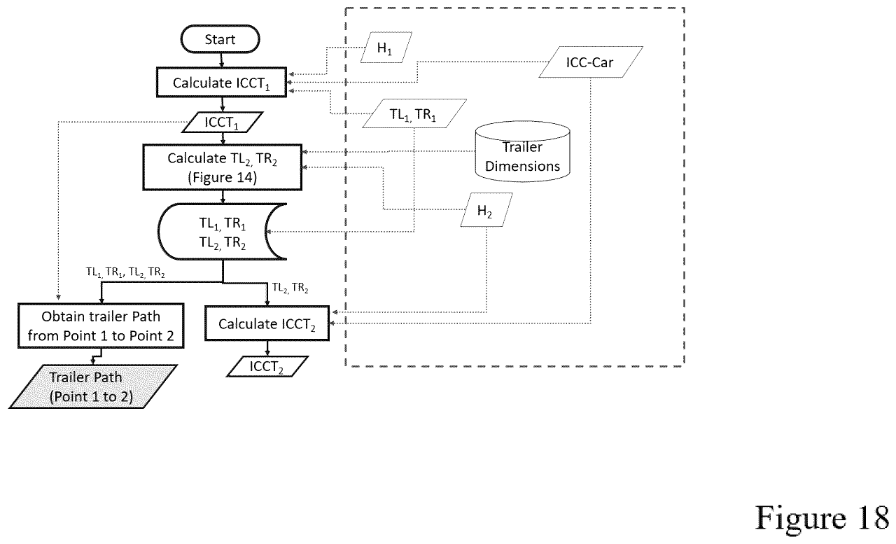

The above procedure can be generalized to any sample car point n, which is shown in FIG. 16. In FIG. 16, the main flow is on the left side and the right side shows predetermined data, ICC-Car and Hₙ, which are used during the main prediction process. FIG. 17 shows an example flow that can obtain ICC-Car and Hₙ given a steering wheel angle. Note in FIG. 16 that every iteration uses ICCT that was obtained in the previous iteration. Therefore, for the first iteration, where ICCT₁ is not already available, this needs to be calculated using TL₁ and TR₁. This first iteration step is more clearly shown in FIG. 18, which is similar to FIG. 16 except for showing how ICCT₁ is obtained using TL₁ and TR₁. As stated earlier, multiple approaches can be used to find TL₁ and TR₁ relative to the car, such as by estimating the hitch angle by use of camera(s), sensor(s), etc.

By doing the procedure of FIG. 16 until all the samples are covered, and by collecting and connecting all the resulting trailer path predictions, the trailer trajectory prediction can be arrived at when the car is at the current position, Point 1. The trailer trajectory prediction will look like the one in FIG. 12.

The invention may include sampling future locations as shown in FIG. 13, and detailed methods and steps to obtain a prediction of full trailer trajectory are disclosed with reference to FIGS. 16-18. Also, how to efficiently obtain the location of the trailer's left and right wheels when the car is at sample location n (TLₙ and TRₙ) is disclosed with reference to FIG. 14. However, as mentioned earlier, the scope of this invention is not restricted to this particular method of obtaining TLₙ and TRₙ.

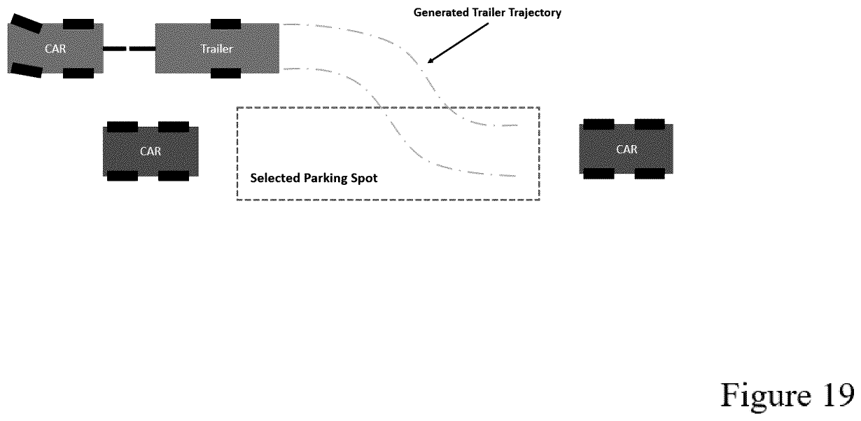

As a final remark, there are several applications that can benefit from the present invention that predicts the trailer trajectory correctly. One application is showing the dynamic guidelines correctly for trailer reversing using a wireless camera attached to the back of the trailer. Another application is automatic trailer parking assist where, with the accurate trailer path prediction and other sensing techniques, the trailer and the car can be automatically put into the available parking spot by adjusting the car's steering wheel as shown in FIG. 19.

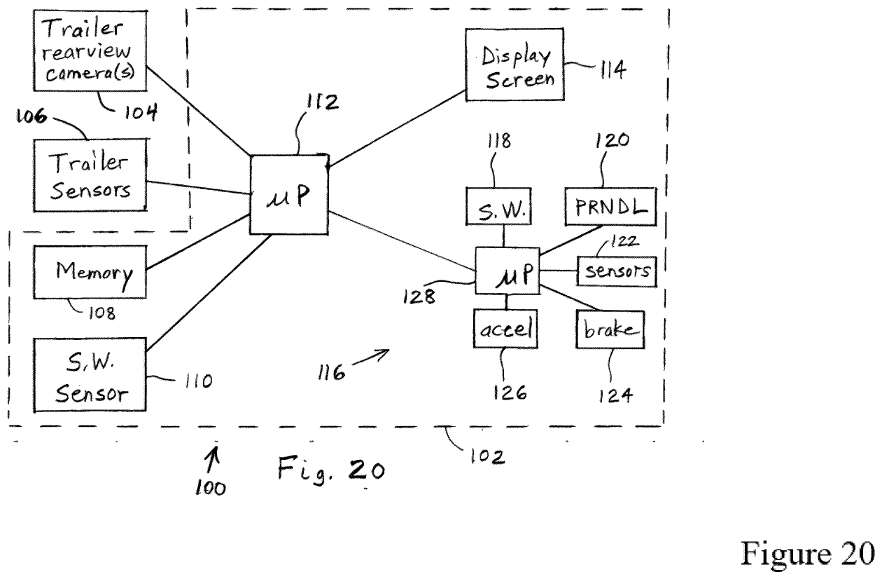

FIG. 20 illustrates one embodiment of a vehicle self-parking arrangement 100 of the present invention, including a motor vehicle 102, trailer rearview camera(s) 104, and trailer sensors 106. Trailer rearview camera(s) 104 may be installed on a trailer pulled by vehicle 12, and may capture images of a scene generally to the rear of vehicle 102.

Trailer sensors 106 detect the location of the trailer, and may specifically detect the location of an axle of the trailer. Trailer sensors 106 may include inertial measurement unit (IMU) sensors, camera sensors, and sensors based on wireless technologies like Bluetooth/Wi-Fi.

Motor vehicle 102 may include a memory device 108, a steering wheel sensor 110, an electronic processor 112, a display screen 114, and an autonomous driving system 116 having a steering wheel 118, a gear control 120, external object sensors 122, a brake 124, an accelerator 126 and an electronic processor 128.

During use, electronic processor 112 may predict a trajectory of a trailer hitched to vehicle 102 based on inputs from camera(s) 104, trailer sensors 106, memory device 108 (e.g., trailer and hitch dimensions), and steering wheel sensor 110 (steering wheel angle). The predicted trailer trajectory may be presented on display screen 114. The predicted trailer trajectory may also be used by autonomous driving system 116 to autonomously park the trailer and vehicle 102, an example of which is illustrated in FIG. 19.

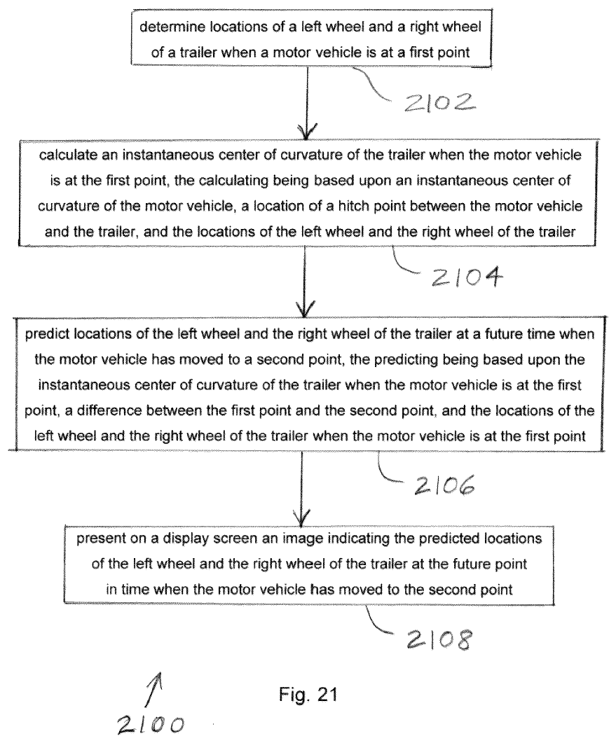

FIG. 21 illustrates one embodiment of a method 2100 of the present invention for predicting a path of a trailer that is coupled to a motor vehicle. In a first step 2102, locations of a left wheel and a right wheel of the trailer when the motor vehicle is at a first point are determined. Multiple approaches can be used to find TL₁ and TR₁ (the left and right trailer wheel locations when the car is at Point 1 relative to the car), such as by estimating hitch angle through a camera, sensors, etc.

In a next step 2104, an instantaneous center of curvature of the trailer when the motor vehicle is at the first point is calculated. The calculating is based upon an instantaneous center of curvature of the motor vehicle, a location of a hitch point between the motor vehicle and the trailer, and the locations of the left wheel and the right wheel of the trailer. For example, the dotted line (i.e., the line connecting ICC-Car and Point H₁) is one of the lines that defines ICC-Trailer when the car is at Point 1 (ICC-Trailer for Point 1 in FIG. 9). As shown in FIG. 7, a line through the trailer wheels intersects a line through the hitch point H₁ and ICC-Car at the instantaneous center of curvature of the trailer ICC-Trailer.

Next, in step 2106, locations of the left wheel and the right wheel of the trailer at a future time when the motor vehicle has moved to a second point are predicted. The predicting is based upon the instantaneous center of curvature of the trailer when the motor vehicle is at the first point, a difference between the first point and the second point, and the locations of the left wheel and the right wheel of the trailer when the motor vehicle is at the first point. For example, from Point 1 to Point 2, the path that the trailer follows is ICCT₁'s circular movement since there is no other trailer path available. At Point 2, TL₂ and TR₂ are still on the circles of ICCT₁, and when the trailer length from the front to the trailer axle is denoted by L, the trailer is L distance away from the hitch point, H₂. Thus, TL₂ and TR₂ can be obtained by finding the intersecting points between ICCT₁'s circles (dashed circles in FIG. 14) and a circle with center H₂ and radius L (solid circle in FIG. 14). FIG. 14 illustrates how the trailer wheel locations at Point 2 can be obtained by using H₂, L, and ICCT₁. Since it is known that the wheels of the trailer follow the circular path around ICCT₁, the movement of the trailer wheels from TL₁ and TR₁ can be calculated based on the distance between hitch points H₁ and H₂, which is a proxy for the difference between Point 2 and Point 1 for the car.

In a final step 2108, an image indicating the predicted locations of the left wheel and the right wheel of the trailer at the future point in time when the motor vehicle has moved to the second point are presented on a display screen. For example, the predicted trailer trajectory may be presented on display screen 114.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A path prediction arrangement for a trailer hitched to a motor vehicle, the arrangement comprising:
means for determining locations of a left wheel and a right wheel of the trailer when the motor vehicle is at a first point;
an electronic processor communicatively coupled to the determining means and configured to:
calculate an instantaneous center of curvature of the trailer when the motor vehicle is at the first point, the calculating being based upon:
an instantaneous center of curvature of the motor vehicle;
a location of a hitch point between the motor vehicle and the trailer; and
the locations of the left wheel and the right wheel of the trailer;
predict locations of the left wheel and the right wheel of the trailer at a future time when the motor vehicle has moved to a second point, the predicting being based upon:
the instantaneous center of curvature of the trailer when the motor vehicle is at the first point;
a difference between the first point and the second point; and
the locations of the left wheel and the right wheel of the trailer when the motor vehicle is at the first point; and
a display screen communicatively coupled to the electronic processor and configured to present an image indicating the predicted locations of the left wheel and the right wheel of the trailer at the future point in time when the motor vehicle has moved to the second point.

2. The arrangement of claim 1 wherein the electronic processor is further configured to:
calculate an instantaneous center of curvature of the trailer when the motor vehicle is at the second point, the calculating being based upon:
an instantaneous center of curvature of the motor vehicle;
a location of a hitch point between the motor vehicle and the trailer when the motor vehicle is at the second point; and
the locations of the left wheel and the right wheel of the trailer when the motor vehicle is at the second point; and
predict locations of the left wheel and the right wheel of the trailer at a future time when the motor vehicle has moved to a third point, the predicting being based upon:
the instantaneous center of curvature of the trailer when the motor vehicle is at the second point;
a difference between the second point and the third point; and
the locations of the left wheel and the right wheel of the trailer when the motor vehicle is at the second point.

3. The arrangement of claim 2 wherein the display screen is configured to present an image indicating a predicted path of the trailer based on the predicted locations of the left wheel and the right wheel of the trailer at the future points in time when the motor vehicle has moved to the second point and the third point.

4. The arrangement of claim 1 further comprising a rearview camera configured to be mounted on the trailer.

5. The arrangement of claim 4 wherein the display screen is mounted on the motor vehicle and is configured to present images dependent upon images captured by the rearview camera.

6. The arrangement of claim 1 further comprising a steering wheel angle sensor configured to be mounted on the motor vehicle, the electronic processor being configured to predict the path to be taken by the trailer dependent upon data received from the steering wheel angle sensor.

7. The arrangement of claim 1 wherein the determining means includes an inertial measurement unit (IMU) sensor, a camera sensor, a Bluetooth-based sensor and/or a Wi-Fi-based sensor.

8. A method for predicting a path of a trailer that is coupled to a motor vehicle, the method comprising:
determining locations of a left wheel and a right wheel of the trailer when the motor vehicle is at a first point;
calculating an instantaneous center of curvature of the trailer when the motor vehicle is at the first point, the calculating being based upon:
an instantaneous center of curvature of the motor vehicle;
a location of a hitch point between the motor vehicle and the trailer; and
the locations of the left wheel and the right wheel of the trailer;
predicting locations of the left wheel and the right wheel of the trailer at a future time when the motor vehicle has moved to a second point, the predicting being based upon:
the instantaneous center of curvature of the trailer when the motor vehicle is at the first point;
a difference between the first point and the second point; and
the locations of the left wheel and the right wheel of the trailer when the motor vehicle is at the first point; and
presenting on a display screen an image indicating the predicted locations of the left wheel and the right wheel of the trailer at the future point in time when the motor vehicle has moved to the second point.

9. The method of claim 8 further comprising:
calculating an instantaneous center of curvature of the trailer when the motor vehicle is at the second point, the calculating being based upon:
an instantaneous center of curvature of the motor vehicle;
a location of a hitch point between the motor vehicle and the trailer when the motor vehicle is at the second point; and
the locations of the left wheel and the right wheel of the trailer when the motor vehicle is at the second point; and
predicting locations of the left wheel and the right wheel of the trailer at a future time when the motor vehicle has moved to a third point, the predicting being based upon:
the instantaneous center of curvature of the trailer when the motor vehicle is at the second point;
a difference between the second point and the third point; and
the locations of the left wheel and the right wheel of the trailer when the motor vehicle is at the second point.

10. The method of claim 9 wherein the presenting step includes presenting on the display screen an image indicating a predicted path of the trailer based on the predicted locations of the left wheel and the right wheel of the trailer at the future points in time when the motor vehicle has moved to the second point and the third point.

11. The method of claim 8 further comprising mounting a rearview camera on the trailer.

12. The method of claim 11 further comprising mounting the display screen on the motor vehicle, and wherein the presented image is dependent upon an image captured by the rearview camera.

13. The method of claim 8 further comprising mounting a steering wheel angle sensor on the motor vehicle, the predicting step being dependent upon data received from the steering wheel angle sensor.

14. The method of claim 8 wherein the determining step is performed by an inertial measurement unit (IMU) sensor, a camera sensor, a Bluetooth-based sensor and/or a Wi-Fi-based sensor.

15. A path prediction arrangement for a trailer hitched to a motor vehicle, the arrangement comprising:
means for determining locations of a left wheel and a right wheel of the trailer when the motor vehicle is at a first point;
an electronic processor communicatively coupled to the determining means and configured to:
calculate an instantaneous center of curvature of the trailer when the motor vehicle is at the first point, the calculating being based upon:
an instantaneous center of curvature of the motor vehicle;
a location of a hitch point between the motor vehicle and the trailer; and
the locations of the left wheel and the right wheel of the trailer;
predict locations of the left wheel and the right wheel of the trailer at a future time when the motor vehicle has moved to a second point, the predicting being based upon:
the instantaneous center of curvature of the trailer when the motor vehicle is at the first point;
a difference between the first point and the second point; and
the locations of the left wheel and the right wheel of the trailer when the motor vehicle is at the first point; and
an autonomous driving system communicatively coupled to the electronic processor and configured to autonomously park the motor vehicle and the trailer dependent upon the predicted locations of the left wheel and the right wheel of the trailer at the future point in time when the motor vehicle has moved to the second point.

16. The arrangement of claim 15 wherein the electronic processor is further configured to:
calculate an instantaneous center of curvature of the trailer when the motor vehicle is at the second point, the calculating being based upon:
an instantaneous center of curvature of the motor vehicle;
a location of a hitch point between the motor vehicle and the trailer when the motor vehicle is at the second point; and
the locations of the left wheel and the right wheel of the trailer when the motor vehicle is at the second point; and
predict locations of the left wheel and the right wheel of the trailer at a future time when the motor vehicle has moved to a third point, the predicting being based upon:
the instantaneous center of curvature of the trailer when the motor vehicle is at the second point;
a difference between the second point and the third point; and
the locations of the left wheel and the right wheel of the trailer when the motor vehicle is at the second point.

17. The arrangement of claim 16 wherein the autonomous driving system is configured to autonomously park the motor vehicle and the trailer based on the predicted locations of the left wheel and the right wheel of the trailer at the future points in time when the motor vehicle has moved to the second point and the third point.

18. The arrangement of claim 15 further comprising a rearview camera configured to be mounted on the trailer.

19. The arrangement of claim 18 wherein the autonomous driving system is configured to autonomously park the motor vehicle and the trailer dependent upon images captured by the rearview camera.

20. The arrangement of claim 15 further comprising a steering wheel angle sensor configured to be mounted on the motor vehicle, the electronic processor being configured to predict the path to be taken by the trailer dependent upon data received from the steering wheel angle sensor.
